(19) United States
(12) Patent Application Publication
(10) Pub. No.: US 2008/0311549 A1
(43) Pub. Date: Dec. 18, 2008

(54) Similar/correlated states comparison method

(76) Inventor: Vasileios Belitsiotis, Trikala (GR)

Correspondence Address: Vasileios Belitsiotis, Fotada, Trikala, 42100, GR

(21) Appl. No.: 12/022,514

(22) Filed: Jan. 30, 2008

Related U.S. Application Data
(60) Provisional application No. 60/898,313, filed on Jan. 31, 2007.

(51) Int. Cl. G09B 19/00; G06F 19/00

(52) U.S. Cl. 434/236; 702/19

(57) ABSTRACT

Ensemble neuronal activity is believed to create cognition and consciousness, in accordance with the Hebian “cell assembly” hypothesis about brain function via interconnected neuronal networks. While specific experimental conditions are set up, functional recording techniques are used to record/monitor the brain, and the more they improve the better. The common experimental results from such techniques are to be used as to monitor brain function, after setting up two (or more), different but very similar experimental conditions. This method aims to elucidate just a part of a mental representation, trying to find the end of the thread in unraveling all of it, if possible. The method main idea is to compare results coming from similar experimental conditions and it is applicable to any field and not only neuroscience.

This is a proposed experimental method to be used in cognitive neuroscience research. The main idea might be useful in many disciplines.

Many different animal tests for brain function have been applied by now. Experiments have been invented but the evolution of the initiating ones has led to the creation of tasks that seem to require more complicated mental functions from the subjects, in order to fulfill them. Such tasks might provide useful insight; however it would also be important to elucidate just a part of a mental representation, aiming to find the end of the thread in unraveling all of it, if possible. The final aim would be to mechanically reconstruct a mental representation from recorded “population ensemble activity”. This endeavor is similar but far more intricate than the achievement by Wilson and McNaughton (1993), who reconstructed the trajectory of the movement of a rat into a platform, using recordings of “place cell” firing.

An approach of doing so follows:
1. Put an animal in two almost identical environmental conditions, inducing only a slight difference.
2. Make large scale recordings in both cases, from as many cells in the “assembly” as possible, if not all.
3. Analyze data statistically/computationally (or in any possible way) from paired trials as to find a reliable difference in neuronal traits, which could represent the way the brain encoded the slight environmental deference.

If such a difference is found, it might reflect a means of perception or even awareness that could be proven the “Rosetta stone” of mental function, contributing first of all in defining what are cognition and most importantly consciousness, for which a clear definition remains elusive, and secondly elucidating them. For example, one of the existing theories for consciousness argues that it is actually an orchestra of the ensemble neuronal activity (Flohr, 2006), in contrast to others that, perhaps justifiably, are more skeptical in giving a definition. Such a method could help progress and either support or reject the former and other similar theories.

An interesting experiment for the proposed method is the use of cue cards which are rotated around the platform an animal lies in (Hafting et al., 2005; Quirk et al., 1992; Muller & Kubie, 1987; Lenk-Santini et al., 2002), (Box 1). The different position of the cue card while everything else is the same is a slight difference.
Box 1. A cue card experiment. Animal is enclosed into a cylindrical platform made of see through walls. Cue card lies on the outside of the walls and it is visible from the subject. If the animal is taken away from the platform and rotation of the cue card occurs, then when the animal is put back it has been observed that there is a shift in the “place field”, which furthermore matches the degrees of rotation (Quirk et al., 1992; Muller & Kubie, 1987; Lenk-Santini et al., 2002). Interestingly, if the animal stays in the platform and sees the rotation, “place fields” do not usually shift (Lenk-Santini et al., 2002). Both these results could be useful for the proposed method, urging to find in each case a reliable difference or even a common trait (after conducting many trials). In Quirk et al. (1992) recordings come from cells in the mEC. “Grid” appearance was not revealed in this experiment at the time it was done. Nevertheless, it is revealed in current ones and rotation of a single directional landmark is shown to induce a corresponding rotation of the grid (Jeffery & Burgess, 2006; Hafting et al., 2005).

This is a seemingly simple test that puts the animal in two different conditions. It would probably be best for the previously mentioned similar/correlated states comparison method to eliminate other external cues such as ruff floors, wall orientation cues etc.

Morphed box experiments might also be applicable, where the slight difference is the altered shape of the walls of the platform, from square, to intermediate octagons, and to circle.

Another application could be the event arena (Day et al., 2003), (Box 2).
Box 2. Event arena experiment. The arena is square, it has one staring box at the middle of each side, and in the arena there are 49 wells filled with sand. Rats are put in one of the four starting boxes, where they are cued with a specific odor using an odor-emitting food pellet and then are let into the arena. In one of the 49 wells is put grinded (non-consumable) same odor emitting pellet; hence rats are trained to retrieve same odor from the specific well. A similar procedure occurs for a second odor, using a different starting box that gets related to a different well for retrieval. One of the test trials is to cue rats in a start box with one of the two odors previously trained for, and see if they will go to the correct well, but this time there are many wells in the arena emitting all short of different odors. The two wells that the subjects were trained for still emit the same familiar odors. Most rats choose the correct well, many choose the other familiar well, a few choose novel wells. One of the states for comparison is rats choosing novel wells compared to those choosing the correct one, and so on. It would be useful to know if there is activation of different brain areas between these two different groups of animals. A possible event arena disadvantage is the need for complicated brain functions.

The potential reliable difference would be an overall stable attribute of the population of the neurons recorded within a dynamic process. For example some neurons provide different recordings even though an animal is put for the second time in the same condition. A key point is that there is a sum of recorded cells for one trial. If in the second of the trials/states for comparison, one neuron gives similar recordings as another one did in the first trial/state, it could be accounted as equivalent or same action, in spite of coming from a different cell. Hence, it might be the amount of identical neuronal activity within the “cell assembly” that matters, and possibly the spatio-temporal distribution of the assembled neurons. Of course appropriate multi state comparison experiments can also be used, if helpful.

Another experimental application of the proposed method can be a behavioral test involving information that is considered innate. Such information is the animal awareness of avoiding consumption of poisonous plants/food. Hence, animal subjects can be cued with naturally-avoided (poisonous) food, and the comparison would be cueing with non-avoided (non-poisonous) food. fMRI can be used to locate areas of interest, which get activated when such food is presented to the subjects. Then large-scale recordings can follow and subsequently the similar/correlated states comparison method.

It could be possible that genes influence or guide the creation of brain networks that hold the innate regarded information, since embryo development and on.

Hereby is a speculation about how interconnected brain networks are created, involving experience dependence. Maybe each neuron has a predisposition for some short of external input. Possibly, its activity occurs within a certain range, which might be critical for the type of information it can encode (or vice versa). Hence, there might be a suitable preference for which neurons will participate in the engram of a specific type of input. This could lead to a categorization of information within the brain, suitable to give the potential of coalitions between different “cell assemblies”. Therefore, even if information was acquired in separate occasions and environmental conditions, there might be some features that led to having common neurons in their engrams, allowing combination. In contrast, another speculation is that after information storage takes place into engrams, possibly adequate synapses between neurons of different memory traces (engrams) occurs, working as bridges, thus allowing combination. These speculations could also coexist.

### APPENDIX

### Supplementary Material

Current Technical Advances

The main techniques available today in cognitive-behavioral neuroscience for studying the intact brain are field potential analysis (electroencephalography (EEG), magnetoencephalography (MEG)), imaging of energy production in brain areas (functional magnetic resonance imaging (fMRI)), positron emission tomography (PET) and single-cell recording. The last has led to much progress in neuroscience until today (Buzsaki, 2004). However, combination of all these techniques, along with further advances will be needed for elucidating brain function, as much as possible.

Functional recording is an invasive method, done by putting the bare tip of an insulated wire in the brain that lies close to neurons. However, there is tissue damage, which worsens by increasing the number of the recording electrodes. Interconnected neurons are not adjacent, but the anatomical location of many is within a small volume. The cells however, are of different types, such as principal cells and various interneurons. The ensemble activity by many of them gives rise to mental phenomena and behavior (Buzsaki, 2004). Therefore, it is important that the used method achieves simultaneous, reliable recordings from many neurons, for all possible traits of their single and cooperative activity, within a small area and with the minimum tissue damage.

A fairly recent advance was the tetrode; a multi-site extracellular recording technique that has big advantages such as monitoring from many neurons, low impedance recording tips and mechanical stability. The use of more than one recording site allows efficient triangulation of the distance that a recorded neuron lies from each electrode. This is because the amplitude of the same action potential recorded by separate electrodes differs in a proportional manner to these distances (the bigger the distance the smaller the amplitude). Hence, the location of the neuron can potentially be revealed, allowing spatio-temporal monitoring of interconnected networks. Tetrodes are made of four wires having a spread of ≈50 μm. Long term recordings in live, behaving animals are also feasible. The recording tip does not have to lie extremely close to a neuron (Box 3). Theoretically, recordings can be made within a cylindrical area of 140 μm radius, surrounding the tetrode, which in the rat CA1 encompasses about 1000 cells. In reality though, with the recording probes and spike sorting algorithms available at present, reliable recordings can be made from around 100 neurons within a much smaller area (Box 3). Cells damaged by the blunt ends of the tetrode wires, silent ones and those having small amplitude action potentials are not recorded (Buzsaki, 2004). In practice though, even less than 10 get shorted out.
Box 3. Tetrode recording. The action potential amplitude of most neurons (≧60 mV) suffice for reliably recording and separating their activity within a radius of 50 μm around a tetrode, which encompasses more than one hundred cells (≈140) in the rat CA1. Action potentials are detectable from an area with a radius of 140 μm encompassing more than one thousand neurons (≈1100). Improvement of the current technologies will allow more efficient recordings.

More recently, silicon probes have been manufactured. They are Micro-Electro-Mechanical-System (MEMS) recording devices, have all the advantages of tetrodes but are much smaller in size; they can also be arranged in a wider area and in different cortical layers. Multi-shank available probes today can record from about 100 well separated cells (Buzsaki, 2004), (Box 4).
Box 4. An 8-shank silicon probe. It is usually made of iridium recording sites (tip edges), which are placed about 200 μm apart in a brain area, recording from different cell populations.

In order to understand the transformations within one neuron or a whole “assembly”, information about the input received and the output produced is needed. However, no current method can reliably monitor input from all neuronal dendrites and spines. Nevertheless, high density silicon shank recordings, could both monitor ensemble spiking output and estimate summed input (Buzsaki, 2004).

Current functional recording research focuses on establishing, correlating and interpreting ensemble neuronal activity but is mainly restricted to the MTL. It seems as an effort to first elucidate the seemingly most important brain networking areas and then expand to others in a holistic approach, which nevertheless might be the most important step of all. fMRI results from all brain areas could guide this future expansion.

1. The Similar/correlated sates comparison method is applicable to cognitive neuroscience research and the main idea for it is to compare results coming from different but similar experimental conditions/set ups. There are a series of trials in one experimental set up and another series of trials in a second experimental set up. The second experimental set up is similar to the first (there could also be more that two similar set ups, leading to multi-comparisons of their results). Experimental conditions are specific and intentionally sets up to be similar, inducing a slight difference between different set ups, in order to get results from each series of trials for purposes of comparison. These results will be compared statistically, computationally, manually or in any possible way of comparison, most likely working with a possibility elimination process.

2. The Similar/correlated sates comparison method aim, according to claim 1, is to solve out just a part of a mental representation, using the difference in the experimental results (when monitoring the brain) due to the slight difference in the experimental set up, trying to find the end of the thread and earn insight or unravel all of it, if possible.

3. The Similar/correlated sates comparison method, according to claim 1, can give insight and aid in elucidating the function of storing information in the brain, and other such cognitive phenomena.

4. For the Similar/correlated sates comparison method, according to claim 1, four specific experiments are proposed. These use the cue card with a see through walled platform, morphed boxes, the event arena, and naturally aware poisonous food compared to non-poisonous food.

5. The Similar/correlated sates comparison method, according to claim 1, could be used in any field and not only neuroscience, where instead of experimental results there can be anything applicable to be compared, and instead of a series there can be just one, aiming to earn insight for what can be applicable.
